(19) United States
(12) Patent Application Publication
(10) Pub. No.: US 2016/0268787 A1
(43) Pub. Date: Sep. 15, 2016

(54) INSTALLATION STRIPPER

(71) Applicant: Donald Taucher, West Mifflin, PA (US)

(72) Inventor: Donald Taucher, West Mifflin, PA (US)

(21) Appl. No.: 14/641,705

(22) Filed: Mar. 9, 2015

(51) Int. Cl. H02G 1/12

(52) U.S. Cl. CPC H02G 1/1256

(57) ABSTRACT

An installation stripper for the removal of insulation surrounding a wire which includes: a base; a platform mounted on the base; a first frame at a first end of the platform; a second frame at a second end of the platform; a first block between the first frame and second frame; at least two springs extending from the platform to support the first block between the first frame and second frame; a plurality of grooves in the first block, where the plurality of grooves each are capable of receiving wires; a second block mountable onto the first block, where the second block includes a plurality of grooves aligned with plurality of grooves on the first block creating a passage way for wires; and a blade extending upward from the first block, where the blade strips the insulation from the wire. The plurality of grooves on the first block and plurality of grooves on the second block are V-shaped. The stripping of the insulation exposes metal wire, where the metal wire is a recyclable metal.

### BACKGROUND OF THE INVENTION

1. Field of Invention

The present invention relates to a device used to strip installation from a copper wire to exposed the copper wire for recycling purposes.

2. Description of Related Art

Copper is common metal that is used in various applications. One common application of copper is the use of copper in electrical wiring. One advantageous aspect of copper is that it is a recyclable metal that rarely loses much quality during the recycling process. As such it is a valuable metal that is collected for recycling purposes. As stated copper is commonly used in wiring, cable, electrical motors, electrical circuits and other electrical applications due to the conductivity related to copper. As a result any wiring that is discarded is usually stripped in order to obtain the copper from the wiring for recycling purposes. Wiring typically includes an insulating cover made of plastic, rubber or other material that insulates the wire to allow the conductivity of electricity to copper. Wire comes in various gauges and as a result various thicknesses. In order to speed the process up of recycling copper wire it would be advantageous to have a device that is used to strip the insulating covering from a wire in an efficient manner.

### SUMMARY OF THE INVENTION

The present invention relates to an installation stripper for the removal of insulation surrounding a wire which includes: a base; a platform mounted on the base; a first frame at a first end of the platform; a second frame at a second end of the platform; a first block between the first frame and second frame; at least two springs extending from the platform to support the first block between the first frame and second frame; a plurality of grooves in the first block, where the plurality of grooves each are capable of receiving wires; a second block mountable onto the first block, where the second block includes a plurality of grooves aligned with plurality of grooves on the first block creating a passage way for wires; and a blade extending upward from the first block, where the blade strips the insulation from the wire. The plurality of grooves on the first block and plurality of grooves on the second block are V-shaped. The stripping of the insulation exposes metal wire, where the metal wire is a recyclable metal.

### BRIEF DESCRIPTION OF DRAWINGS

FIG. 1 depicts a side view of an installation stripper in accordance with the present invention.

FIG. 2 depicts a top view of the installation stripper in accordance with the present invention.

### DETAILED DESCRIPTION

The present invention provides an installation stripper that effectively removes insulation from copper wiring. The installation stripper according to the present invention includes a base, which supports a frame that encloses springs that support a bottom block that is adjoined to a top block. V-shaped grooves are provided through both the top and bottom block. These grooves receive wiring that is pulled through the grooves. While being pulled the wires come in contact with a cutting blade that cuts and removes the insulation surrounding the copper wire. The grooves over the surface of the cutting block enable the wire to be fed through the grooves as a blade underlying the grooves within the bottom block scrapes insulation. The springs provide resilient pressure into the grooves onto the wires to ensure that the insulation comes in contact with the blade.

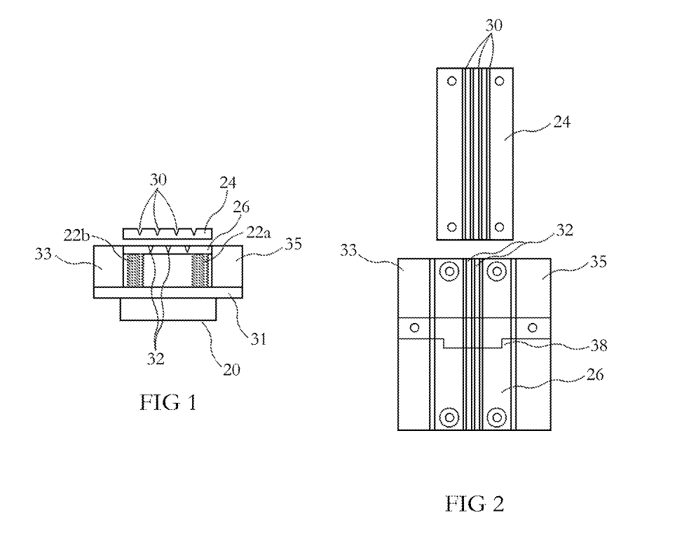

In reference to FIG. 1, a side view of an installation stripper in accordance with the present invention is depicted. The installation stripper includes a base 20 that supports the components of the installation stripper. The various components include a platform 31 with a first frame 33 and a second frame 35 at each end of the platform 31. This arrangement creates an opening between the first frame 33 and the second frame 35. Springs 22a, 22b are mounted on the top surface of the platform 31 then connect to a bottom block 26. The block 26 includes the V-shaped grooves 32 running along the length of the block 26. A top block 24 is shown that has V-shaped grooves 30 that adjoin to the grooves shown in the bottom block 26. The springs 22a, 22b provide resilient pressure on the bottom block 26 and when the top block 24 is adjoined, wires may be fed through the grooves provided.

A top view of the installation stripper is depicted in FIG. 2. As shown, a blade 38 extends across the grooves 32. The blade 38 enables the cutting of the installation from the wires that fit through the grooves 32. The block 26 extends is supported within the first frame 33 and second frame 35 by the springs 22a, 22b shown in FIG. 1. A total of four springs may be used to support the block 26. Use of the installation stripper according to the present invention enables an effective means to remove insulation from wiring and expose copper for recycling purposes. This same type of cutting mechanism may be used with aluminum or any other wiring for recycling purposes also. The instant invention has been shown and described in what it considers to be the most practical and preferred embodiments. It is recognized, however, that departures may be made there from within the scope of the invention and that obvious modifications will occur to a person skilled in the art.

What is claimed is:

1. An installation stripper for the removal of insulation surrounding a wire comprising:
a. a base;
b. a platform mounted on the base;
c. a first frame at a first end of the platform;
d. a second frame at a second end of the platform;
e. a first block between the first frame and second frame;
f. at least two springs extending from the platform to support the first block between the first frame and second frame;
g. a plurality of grooves in the first block, where the plurality of grooves each are capable of receiving wires;
h. a second block mountable onto the first block, where the second block includes a plurality of grooves aligned with plurality of grooves on the first block creating a passage way for wires; and
i. a blade extending upward from the first block, where the blade strips the insulation from the wire.

2. The installation stripper according to claim 1, where the plurality of grooves on the first block and plurality of grooves on the second block are V-shaped.

3. The installation stripper according to claim 1, where the stripping of the insulation exposes metal wire.

4. The installation stripper according to claim 3, where the metal wire is a recyclable metal.

5. The installation stripper according to claim 4, where the recyclable metal is copper.

6. The installation stripper according to claim 4, where the recyclable metal is aluminum.
